(19) United States
(12) Patent Application Publication
(10) Pub. No.: US 2010/0246172 A1
(43) Pub. Date: Sep. 30, 2010

(54) LED LAMP

(75) Inventor: You-Xue Liu, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/417,665

(22) Filed: Apr. 3, 2009

(30) Foreign Application Priority Data
Mar. 25, 2009 (CN) 200910301128.0

(51) Int. Cl. F21V 1/00; F21V 29/00; F21S 4/00

(52) U.S. Cl. 362/235; 362/373; 362/249.02

(57) ABSTRACT

An LED lamp includes a housing, an LED module received in the housing and a lamp holder engaging the housing to position the LED lamp to a panel. The housing includes a base and a plurality of fins integrally extending from the base. The base defines a receiving recession in a bottom thereof, receiving the LED module therein. The lamp holder is connected to the base of the housing via fasteners extending through the lamp holder and inserting in the base of the housing. An illumination angle of the LED lamp is adjustable within the lamp holder via rotation of the housing about the fasteners.

### BACKGROUND

1. Technical Field

The disclosure relates to LED (light emitting diode) lamps, and, more particularly, to an LED lamp having a compact structure.

2. Description of Related Art

An LED lamp assembly is a type of solid-state lighting that utilizes LEDs as a source of illumination. An LED is a device for transferring electricity to light by using a theory that, if a current is made to flow in a forward direction through a junction region comprising two different semiconductors, electrons and holes are coupled at the junction region to generate a light beam. The LED has an advantage that it is resistant to shock, and has a nearly infinite lifetime under a specific condition; thus, the LED lamp is intended to be a cost-effective yet high quality replacement for incandescent and fluorescent lamps.

Due to advantages of the LED, the LED lamp is widely used for outdoor and indoor lighting or decorating purposes.

Conventionally, an LED lamp includes a heat sink having a base, an LED module attached to a bottom surface of the base of the heat sink and a housing receiving the LED module therein and engaging the base of the heat sink. Usually, the base of the heat sink is fastened to the housing via screws extending through the base of the heat sink to screw into the housing. Stability of the threaded connection between the heat sink and the housing is poor. The heat sink and the housing are prone to be loosened when the LED lamp suffers vibration. Moreover, it is time-consuming and laborious to screw the screws to the housing through the base of the heat sink in order to combine the heat sink to the housing together.

What is needed, therefore, is an LED lamp having a compact structure with an improved stability.

### BRIEF DESCRIPTION OF THE DRAWINGS

Other advantages and novel features of the disclosure will become more apparent from the following detailed description of an embodiment/embodiments when taken in conjunction with the accompanying drawings.

FIG. 1 is an isometric, assembled view of an LED embedded spotlight lamp in accordance with an embodiment of the disclosure.

FIG. 2 is an exploded view of FIG. 1.

FIG. 3 is an inverted view of FIG. 2.

FIG. 4 is a partially assembled view of FIG. 3.

FIG. 5 is a cross-section of FIG. 1.

FIG. 6 is a cross-section view of FIG. 1, taken along line VI-VI thereof.

### DETAILED DESCRIPTION

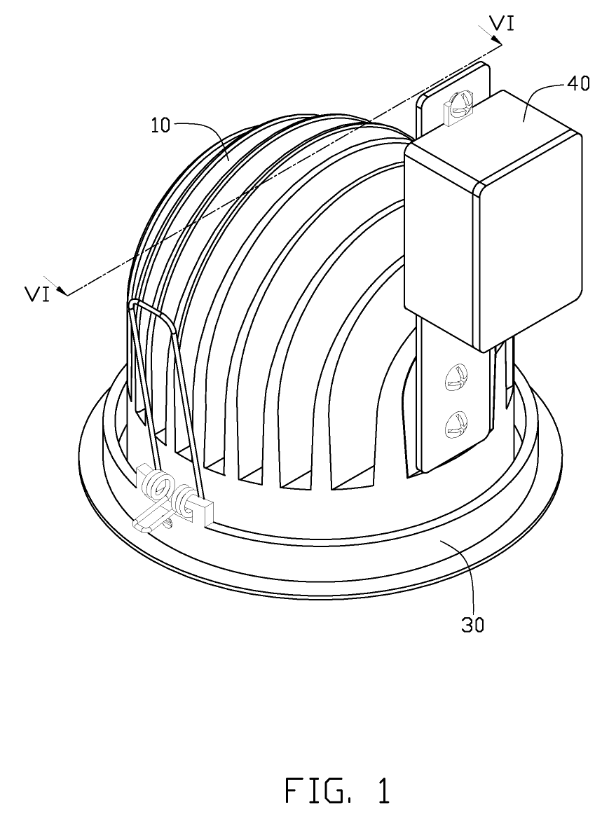

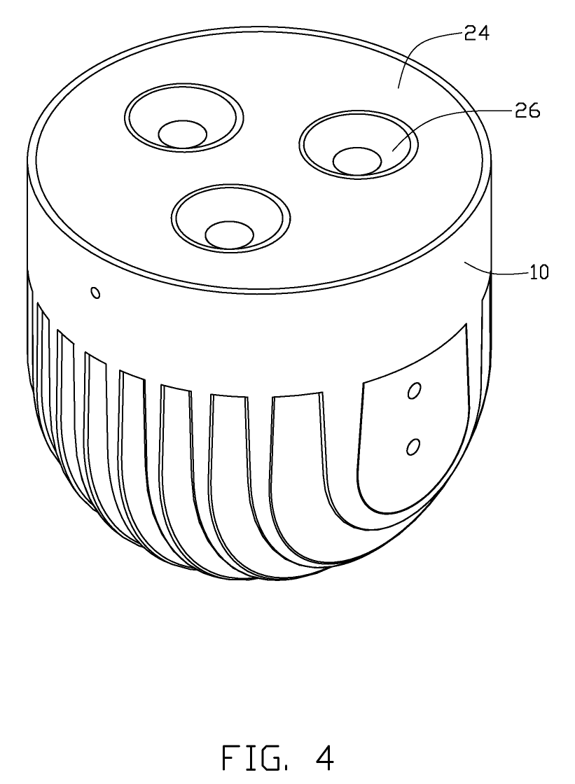

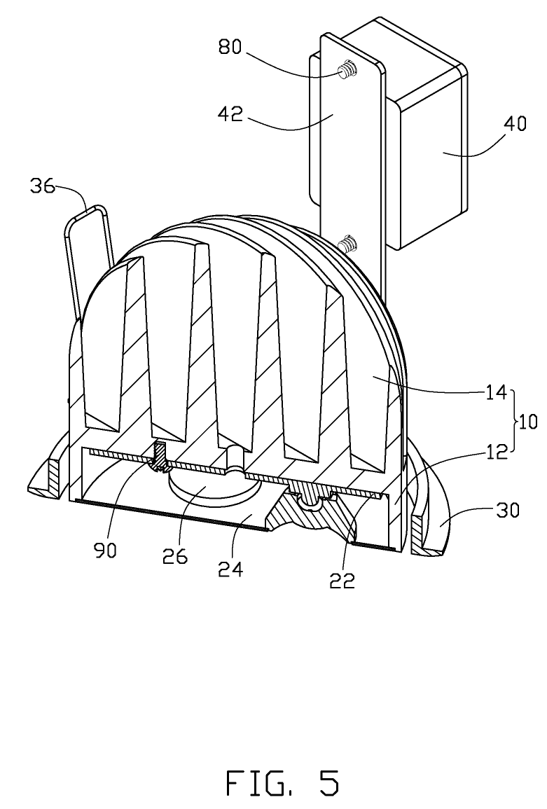

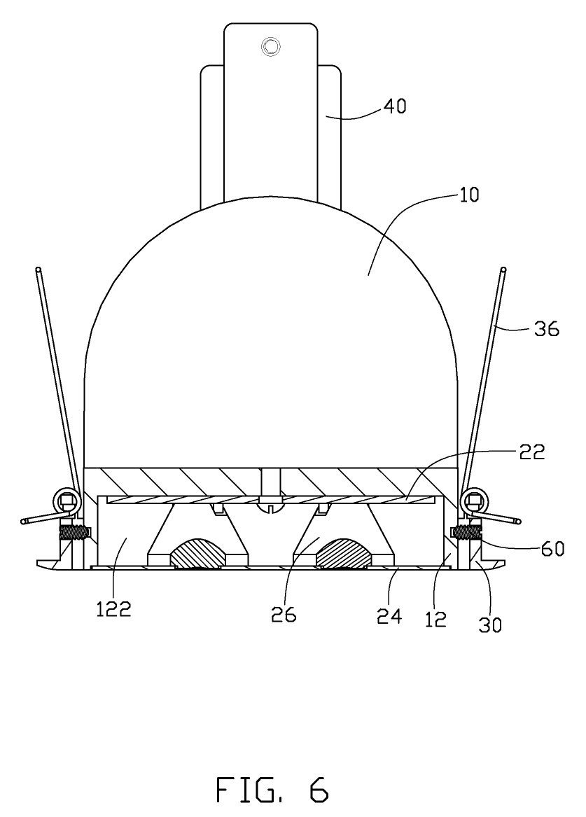

Referring to FIGS. 1-6, an LED embedded spotlight lamp (hereafter LED lamp) in accordance with an embodiment is shown. The LED lamp comprises a housing 10, an LED module 20 received in and mounted to a bottom of the housing 10 and a lamp holder 30 connected to the bottom of the housing 10 for positioning the LED lamp to a panel (not shown). The LED lamp further comprises a driving circuit module 40 mounted to a lateral side of the housing 10.

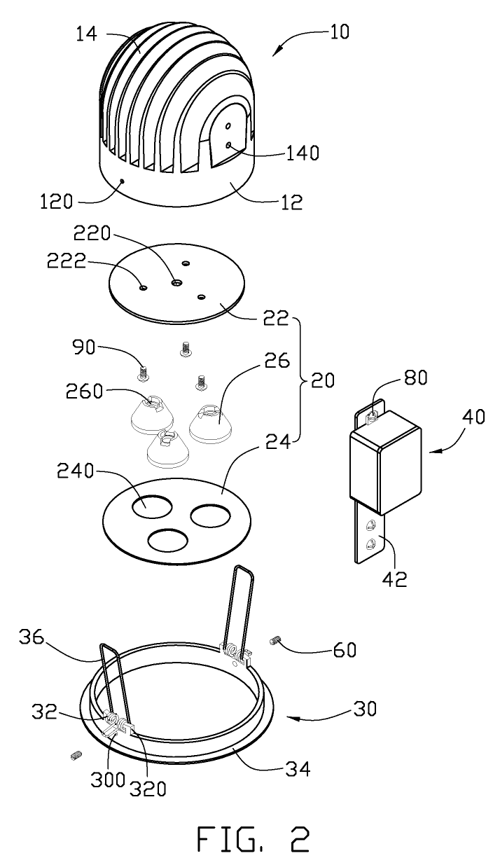

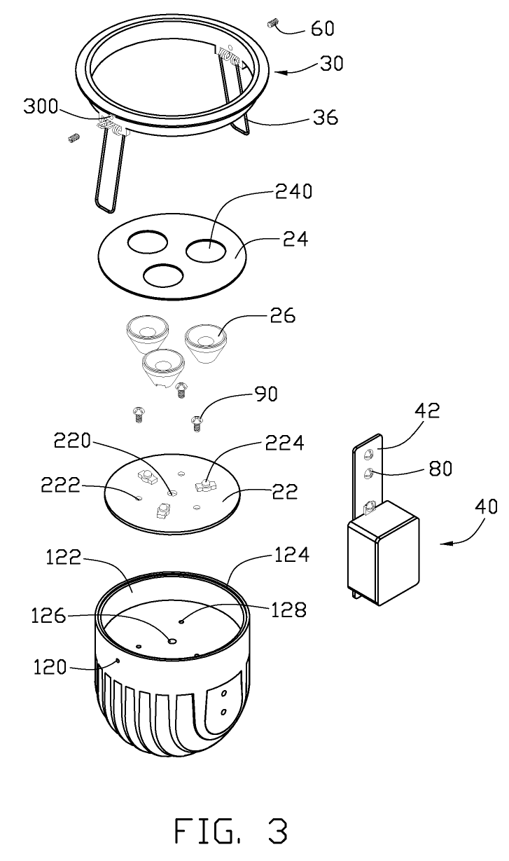

Referring also to FIGS. 2-3, the housing 10 is integrally formed of a metal with good heat conductivity such as aluminum, copper or alloy thereof. The housing 10 comprises a circular base 12 at the bottom thereof and a plurality of fins 14 integrally extending perpendicularly and upwardly from a top surface of the base 12. A pair of fixing holes 120 are respectively defined in two opposite lateral sides of the base 12, allowing fasteners 60 extending through the lamp holder 30 to threaedly engage therein thereby to couple the lamp holder 30 to the base 12 of the housing 10. A circular receiving recession 122 is defined in a bottom of the base 12, receiving the LED module 20 therein. The base 12 defines an annular channel 124 at a circumference of the receiving recession 122, receiving an edge of the lens 24 therein. A through hole 126 is defined in a center of the bottom of the base 12. The through hole 126 passes through the top surface of the base 12 and communicates with the air, whereby electrical wires from the driving circuit module 40 extend through the base 12 from a top of the housing 10 via the through hole 126 to electrically connect with the LED module 20 received in the receiving recession 122 of the base 12. Three screwing holes 128 are defined in the bottom of the base 12 and are evenly distributed on an imaginary circle about the through hole 126 as the center. The fins 14 each have an arched configuration and gradually increase in height from two opposite sides to a middle portion of the base 12. The fins 14 each gradually decrease in thickness from a lower portion to an upper portion of the housing 10, thereby quickly dissipating heat generated by the LED module 20. The two outermost fins 14 each define a pair of mounting holes 140, for extension of screws 80 therein to fix the driving circuit module 40 to one of the two outermost fins 14 of the housing 10. In this embodiment, the housing 10 functions as a heat sink for removing heat from the LED module 20 and further functions as a cover for covering and protecting the LED module 20; therefore, the housing 10 replaces a combination of a heat sink and a cover separable from and engaging with the heat sink by screws of a conventional LED lamp. In the present LED lamp, there is no necessity for screws to secure a housing to a heat sink.

The LED module 20 comprises a round printed board 22, a round lens 24 and three cup-shaped reflectors 26 sandwiched between the printed board 22 and the lens 24. The printed board 22 defines a center hole 220 and three fixing holes 222 in alignment with the through hole 126 and the screwing holes 128 of the base 12 of the housing 10, respectively, whereby screws 90 extending through the fixing holes 222 of the printed board 22 screw in the screwing holes 126 of the base 12 to mount the printed board 22 on the bottom of the base 12. Three LEDs 224 are attached on a bottom surface of the printed board 22 and each are located between two adjacent fixing holes 222. The lens 24 has a size slightly bigger than the printed board 22 and smaller than the circumference of the bottom of the base 12. An outer edge of the lens 24 is inserted in the annular channel 124 of the bottom of the base 12 to be mounted in the bottom of the base 12 of the housing 10, thereby tightly sandwiching the cup-shaped reflectors 26 between the printed board 22 and the lens 24. The lens 24 defines three circular openings 240 located corresponding to the LEDs 224 of the printed board 22, whereby light emitted by the LEDs 224 passes through the lens 24 to provide an illumination. Each cup-shaped reflector 26 defines a circular opening 260 in a top thereof for extension of a corresponding LED 224 therethrough. The cup-shaped reflectors 26 each receive a respective LED 224 therein and abut against a top surface of the lens 24 around the openings 240 of the lens 24 when the lens 24 tightly engages in the annular channel 124 of the base 12.

The lamp holder 30 is connected to the base 12 of the housing 10 via the fasteners 60 extending therethrough and inserting in the fixing holes 120 of the base 12 of the housing 10. The lamp holder 30 has an annular configuration surrounding an outer periphery of the base 12 of the housing 10 and comprises a pair of ears 32 extending upwardly and perpendicularly from a circumference of an upper end thereof. The ears 32 are positioned symmetrically relative to a center of the lamp holder 30. Each ear 32 comprises a pair of curved parts 320 extending from the upper end of the lamp holder 30 and facing each other. A handle 36 is made of a metal wire and has helical portions wrapping around the two curved parts 320 of a corresponding ear 32, thereby securing the handle 36 to the corresponding ear 32. The handles 36 are provided for facilitating fixing of the LED lamp to the panel. A pair of fixing orifices 300 are defined in a sidewall of the lamp holder 30, located under respective ears 32, whereby the fasteners 60 extend through the fixing orifices 300 and insert in the fixing holes 120 of the base 12 of the housing 10 to connect the lamp holder 30 to the base 12 of the housing 10. Since the lamp holder 30 surrounds the outer periphery of the base 12 of the housing 10 with a gap defined therebetween, an orientation of the housing 10 in respect to the lamp holder 30 is adjustable by rotating the housing 10 about the fasteners 60 within a range of the gap. An illumination angle of the LED module 20 is thereby adjustable via rotation of the base 12 of the housing 10 about the fasteners 60. The lamp holder 30 further comprises an annular flange 34 extending parallel and outwardly from the circumference of a lower end thereof. The flange 34 is provided for abutting a front face of the panel around a hole, whereby the lens 24 and the LEDs 224 are exposed to a front of the panel via the hole defined in the panel.

The driving circuit module 40 comprises a fixing plate 42 securing the driving circuit module 40 to the corresponding outermost fin 14 of the housing 10. The fixing plate 42 has a rectangular shape and defines a plurality of holes (not shown), whereby screws 80 extending through the holes of the fixing plate 42 are threadly engaged in the mounting holes 140 of the corresponding outermost fin 14 of the housing 10 to fix the driving circuit module 40 to the lateral side of the housing 10. Since the driving circuit module 40 is positioned outside the housing 10 and remote from the LED module 20 received in the receiving recession 122 of the bottom of the housing 10, heat generated by the driving circuit module 40 does not affect the LED module 20 and is directly dissipated to an outside without the help of the housing 10, whereby the housing 10 can be wholly utilized to dissipate the heat generated by the LED module 20.

In this embodiment, the housing 10 replaces a combination of a heat sink and a cover in a conventional LED lamp, thereby avoiding complex and time-consuming assembly of the heat sink and the cover via screws. Moreover, the housing 10 has advantages of compact structure and excellent stability.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp comprising:
a housing comprising a base and plurality of fins integrally extending from a top thereof, the base defining a receiving recession in a bottom thereof, the base and the fins integrally formed from one piece member;
an LED module received in the receiving recession of the base of the housing and surrounded by the base to provide an illumination through the bottom of the base, heat generated by the LED module being absorbed by the base of the housing; and
a lamp holder engaging the housing and adapted for positioning the LED lamp to a panel;
wherein the lamp holder surrounds the base of the housing with a gap defined therebetween and wherein an orientation of the housing in respect to the lamp holder is adjustable by rotating the housing about at least a fastener extending through the lamp holder and secured in the base of the housing.

2. The LED lamp as claimed in claim 1, further comprising a driving circuit module fixed to an outmost one of the fins of the housing.

3. The LED lamp as claimed in claim 2, wherein the driving circuit module comprises a fixing plate mounting the driving circuit module to the outmost one of the fins of the housing.

4. The LED lamp as claimed in claim 3, wherein the fixing plate of the driving circuit module secured to the outmost one of the fins of the housing via at least one screw.

5. The LED lamp as claimed in claim 1, wherein the LED module comprises a printed board mounted on the bottom of the base of the housing and a plurality of LEDs attached on the printed board.

6. The LED lamp as claimed in claim 5, wherein the LED module further comprises a lens engaging in a circumference of the base of the housing and a plurality of reflectors receiving the LEDs therein and sandwiched between the printed board and the lens.

7. The LED lamp as claimed in claim 6, wherein the base of the housing defines an annular channel in the bottom thereof and an outer edge of the lens of the LED module is secured received in the annular channel to be fixed to the base.

8. The LED lamp as claimed in claim 6, wherein the lens defines a plurality of openings corresponding to the reflectors, respectively.

9. The LED lamp as claimed in claim 6, wherein the lamp holder comprises a handle located at a lateral side thereof, adapted to be fixed to the panel.

10. The LED lamp as claimed in claim 9, wherein the lamp holder comprises an ear extending from an upper thereof and engaging the handle.

11. The LED lamp as claimed in claim 1, wherein the fins of the housing gradually increase in size from two opposite sides to a middle of the housing.

12. The LED lamp as claimed in claim 1, wherein the fins each gradually decrease in thickness from a lower portion to an upper portion of the housing.

13. The LED lamp as claimed in claim 1, wherein the base of the housing defines at least one mounting hole therein, the at least one fastener extending through the lamp holder and screwing in the at least one mounting hole.
